(19) United States
(12) Patent Application Publication
(10) Pub. No.: US 2010/0306234 A1
(43) Pub. Date: Dec. 2, 2010

(54) CACHE SYNCHRONIZATION

(75) Inventors: JUNHUA WANG, SAMMAMISH, WA (US); GAURAV SAREEN, SAMMAMISH, WA (US); YANBIAO ZHAO, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/474,013

(22) Filed: May 28, 2009

(51) Int. Cl. G06F 17/30; G06F 12/08; G06F 12/00

(52) U.S. Cl. 707/769; 711/118; 711/E12.001; 711/E12.017; 707/704; 707/812

(57) ABSTRACT

Methods, systems, and media are provided for synchronizing information across multiple environments of a synchronization system. A search query is received into a frontend infrastructure of a first synchronization environment. The frontend infrastructure checks a local cache manager to see if results already exist for the search query. If existing results are not found, then one or more backend search engines of the first synchronization environment are utilized for the search query. The search results from the backend search engines are saved into the local cache manager of the first synchronization environment. A cache sync notification is created to identify the contents and location of the actual saved results. The cache sync notification is saved in a cache synchronization service located within the first synchronization environment, and broadcast to all other synchronization environments within the synchronization system. The actual results can be retrieved from any other synchronization environment.

### BACKGROUND

A cache is a collection of data which is duplicated from original values stored elsewhere or computed earlier on a computing system. The cache is a temporary storage area where frequently accessed data can be stored for rapid access. Once the data is stored in the cache, it can be used in the future by accessing the cached copy rather than re-fetching or re-computing the original data. Conventionally, the original data takes longer to access or to compute, compared to reading the cache.

The cache may improve latencies and reduce the load to the computing system. However, caches are limited to a particular location within the computing system. Therefore, when service executed by the computing system is replicated geographically, cached data may not be available at the other locations. As a result, search query requests will be served by backend search engines at all locations. Therefore, efforts are duplicated across multiple locations for the same search query. In addition, search results for a search query from multiple locations are not consistent.

### SUMMARY

Embodiments of the invention are defined by the claims below. A high-level overview of various embodiments of the invention is provided to introduce a summary of the systems, methods, and media that are further described in the detailed description section below. This summary is neither intended to identify key features or essential features of the claimed subject matter, nor is it intended to be used as an aid in isolation to determine the scope of the claimed subject matter.

A synchronization system contains multiple synchronization environments executed by different computing devices in a search system. A synchronization environment is a self-contained environment which is capable of receiving a search query, retrieving results that satisfy the search query, and saving the search query results via a cache manager. In addition, the search query results are broadcast to other synchronization environments within the synchronization system. The multiple synchronization environments can be in the same physical location, or they can be located in different geographical locations.

Embodiments of the invention include a synchronization system with multiple synchronization environments, and a method and media for synchronizing available information within that system. Each synchronization environment has a frontend infrastructure, which is operable to receive a search query input from a user. A local cache manager is included in the synchronization environment in order to store search query results or pointers to the search query results. When the frontend infrastructure receives a search query, it checks the local cache manager to see if results for that search query already exist. When existing results are not found in the local cache manager, then one or more backend search engines are used to search the search query obtained from the frontend infrastructure.

When new results for a search query are obtained from the backend search engines, the results are stored in the local cache manager. In addition, a cache sync notification is created, which provides information indicating where the actual search results are located. A cache synchronization service broadcasts the cache sync notification to all other synchronization environments within the synchronization system. The broadcast cache sync notification is received into the frontend infrastructure of each synchronization environment. Each frontend infrastructure saves the cache sync notification into its local cache manager.

Embodiments of the invention also utilize a system, method, and media for retrieving cached search results from other synchronization environments. A frontend infrastructure checks its local cache manager for existing results of a search query request. The search results may not be located in the local cache manager, but there may be a cache sync notification indicating that the desired search results are located in another synchronization environment. In some embodiments of the invention, a frontend infrastructure of one synchronization environment retrieves search results from a frontend infrastructure of another synchronization environment in response to the search request.

### BRIEF DESCRIPTION OF THE DRAWINGS

Illustrative embodiments of the invention are described in detail below, with reference to the attached drawing figures, which are incorporated by reference herein, and wherein:

FIG. 1 is a block diagram illustrating an exemplary operating environment used in accordance with embodiments of the invention;

FIG. 2 is an illustration of a computer-implemented synchronization system, in accordance with embodiments of the invention;

FIG. 2A is an illustration of a computer-implemented synchronization system, in accordance with embodiments of the invention;

FIG. 3 is an illustration of a computer-implemented system for retrieving cached results, in accordance with embodiments of the invention;

FIG. 4 is a flow diagram illustrating a method of synchronizing available information, in accordance with an embodiment of the invention; and

FIG. 5 is a flow diagram illustrating a method of retrieving cached results, in accordance with an embodiment of the invention.

### DETAILED DESCRIPTION

Embodiments of the invention provide systems, methods and computer-readable storage media for the synchronization of information across multiple environments. This detailed description and the following claims satisfy the applicable statutory requirements.

The terms “step,” “block,” etc. might be used herein to connote different acts of methods employed, but the terms should not be interpreted as implying any particular order, unless the order of individual steps, blocks, etc. is explicitly described. Likewise, the term “module,” etc. might be used herein to connote different components of systems employed, but the terms should not be interpreted as implying any particular order, unless the order of individual modules, etc. is explicitly described.

Throughout the description of different embodiments of the invention, several acronyms and shorthand notations are used to aid the understanding of certain concepts pertaining to the associated systems, methods and computer-readable media. These acronyms and shorthand notations are intended to help provide an easy methodology for communicating the ideas expressed herein and are not meant to limit the scope of any embodiment of the invention.

Embodiments of the invention include, without limitation, methods, systems, and sets of computer-executable instructions embodied on one or more computer-readable media. Computer-readable media include both volatile and nonvolatile media, removable and non-removable media, and media readable by a database and various other network devices. Computer-readable media comprise computer storage media and communication media. By way of example, and not limitation, computer-readable media comprise media implemented in any method or technology for storing information. Examples of stored information include computer-useable instructions, data structures, program modules, and other data representations. Media examples include, but are not limited to, information-delivery media, random access memory (RAM), read-only memory (ROM), electrically erasable programmable read-only memory (EEPROM), flash memory or other memory technology, compact-disc read-only memory (CD-ROM), digital versatile discs (DVD), holographic media or other optical disc storage, magnetic cassettes, magnetic tape, magnetic disk storage, and other magnetic storage devices. These examples of media can be configured to store data momentarily, temporarily, or permanently. The computer-readable media include cooperating or interconnected computer-readable media, which exist exclusively on a processing system or distributed among multiple interconnected processing systems that may be local to, or remote from, the processing system. Communication media can be configured to embody computer-readable instructions, data structures, program modules or other data in an electronic data signal.

Embodiments of the invention are directed to computer code or machine-useable instructions, including computer-executable instructions such as program modules, being executed by a computer or other machine. Generally, program modules including routines, programs, objects, components, data structures, and the like refer to code that perform particular tasks or implement particular data types. Embodiments described herein may be implemented using a variety of system configurations, including handheld devices, consumer electronics, general-purpose computers, more specialty computing devices, etc. Embodiments described herein may also be implemented in distributed computing environments, using remote-processing devices that are linked through a communications network or the Internet.

In some embodiments, a computer-implemented method of synchronizing available information is provided. When a search query is received by a first frontend infrastructure of a first environment, the first frontend infrastructure checks a first local cache manager to see if results for the search query already exist. If existing search results are not found in the first local cache manager, then the search query is sent to one or more backend search engines of the first environment. When results of the search query are returned from the one or more backend search engines, the search results are saved into a memory of the first local cache manager. A cache sync notification of these search results is sent from the first frontend infrastructure to a first cache synchronization service of the first environment. The cache sync notification of the search results is then broadcast from the first cache synchronization service to a second frontend infrastructure of a second environment. The broadcast cache sync notification of the search results is then saved into a memory of a second local cache manager of the second environment. In another embodiment, one or more computer-readable storage media may contain computer readable instructions embodied thereon that, when executed by a computing device, perform the above method of synchronizing available information.

In certain embodiments, a method for retrieving results from a first local cache manager by a second environment is provided. When a search query is received by a second frontend infrastructure, a second local cache manager is checked to see if the results of the search query already exist. A cache sync notification of the search query results may be found in the second local cache manager. The cache sync notification may indicate that the results are located in a first environment. A request for the search query results is then forwarded to a first frontend infrastructure of the first environment. The first frontend infrastructure retrieves from a first local cache manager the search query results, which are then sent to the second frontend infrastructure. The cache sync notification is removed from the second local cache manager, and the search query results are then saved by the second local cache manager. In another embodiment, one or more computer-readable storage media may contain computer-readable instructions embodied thereon that, when executed by a computing device, perform the above method for retrieving results from a first local cache manager by a second environment.

In yet another embodiment, the present invention is directed to a computer-implemented synchronization system, containing a plurality of cache synchronization environments. Each cache synchronization environment is executed by a computer and includes a frontend infrastructure, one or more backend search engines, a local cache manager, and a cache synchronization service. The frontend infrastructure is operable to receive a search query, and to send and receive cache sync notifications of search query results to and from other synchronization environments. The one or more backend search engines are operable to receive and search the search query obtained from the frontend infrastructure, and to return the results to the frontend infrastructure. The local cache manager is operable to store search query results. The local cache manager is also operable to store cache sync notifications of search query results, wherein the search query results are stored in a different synchronization environment. The cache synchronization service is operable to send and receive cache sync notifications of search query results to and from one or more frontend infrastructures located in other respective synchronization environments.

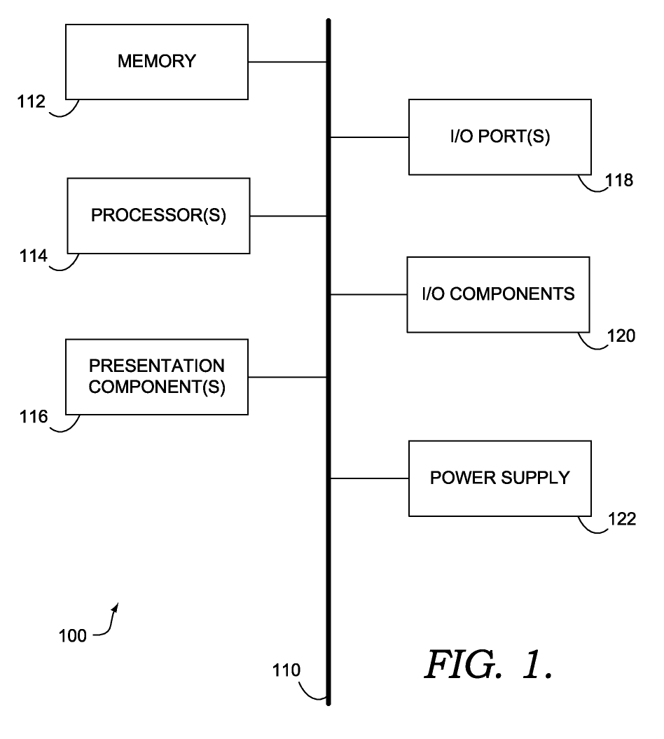

Having briefly described a general overview of the embodiments herein, an exemplary computing device is described below. Referring initially to FIG. 1, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated. In one embodiment, the computing device 100 is a conventional computer (e.g., a personal computer or laptop).

The computing device 100 includes a bus 110 that directly or indirectly couples the following devices: memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, delineating various components in reality is not so clear, and metaphorically, the lines would more accurately be gray and fuzzy. For example, one may consider a presentation component 116 such as a display device to be an I/O component. Also, processors 114 have memory 112. It will be understood by those skilled in the art that such is the nature of the art, and as previously mentioned, the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1, and are referenced as “computing device.”

The computing device 100 can include a variety of computer-readable media. By way of example, and not limitation, computer-readable media may comprise RAM, ROM, EEPROM, flash memory or other memory technologies, CDROM, DVD or other optical or holographic media, magnetic cassettes, magnetic tape, magnetic disk storage or other magnetic storage devices, or similar tangible media that are configurable to store data and/or instructions relevant to the embodiments described herein.

The memory 112 includes computer-storage media in the form of volatile and/or nonvolatile memory. The memory 112 may be removable, non-removable, or a combination thereof. Exemplary hardware devices include solid-state memory, hard drives, cache, optical-disc drives, etc. The computing device 100 includes one or more processors 114, which are operative to read data from various entities such as the memory 112 or the I/O components 120. The presentation components 116 are operative to present data indications to a user or other device. Exemplary presentation components 116 include display devices, speaker devices, printing devices, vibrating devices, and the like.

The I/O ports 118 are operative to logically couple the computing device 100 to other devices including the I/O components 120, some of which may be built in. Illustrative I/O components 120 include a microphone, joystick, game pad, satellite dish, scanner, printer, wireless device, etc.

The components described above in relation to the computing device 100 may also be included in a wireless device. A wireless device, as described herein, refers to any type of wireless phone, handheld device, personal digital assistant (PDA), BlackBerry®, smartphone, digital camera, or other mobile devices (aside from a laptop), which are operable to communicate wirelessly. One skilled in the art will appreciate that wireless devices will also include a processor and computer-storage media, which are operable to perform various functions. Embodiments described herein are applicable to both a computing device and a mobile device. In embodiments, computing devices can also refer to devices which operate to run applications of which images are captured by the camera in a mobile device.

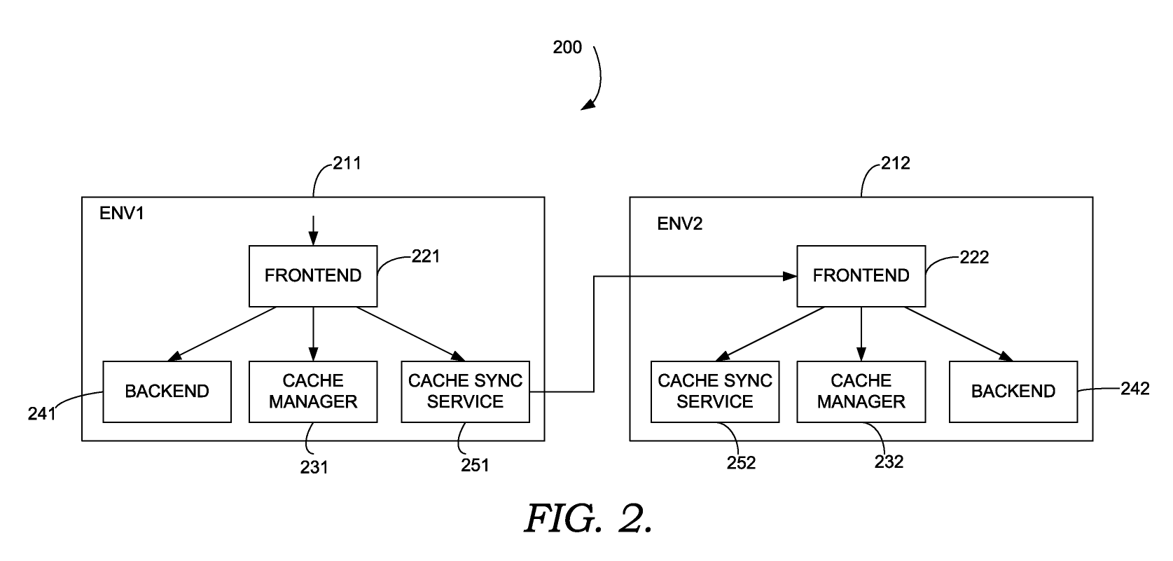

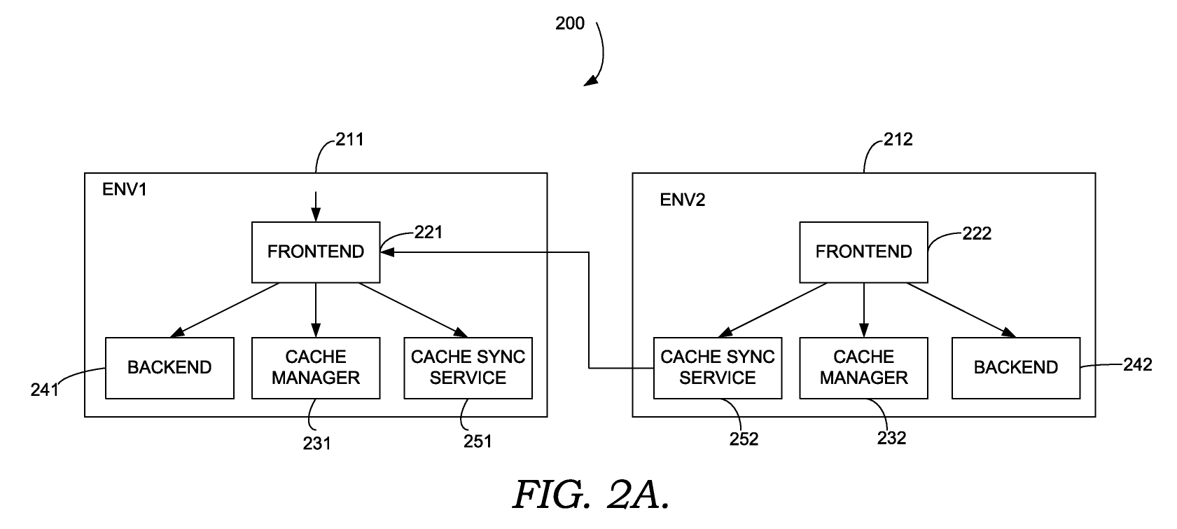

The computing system described above is configured to be used with a cache synchronization system, such as the computer-implemented synchronization system illustrated in FIG. 2. The cache synchronization system 200 contains at least two synchronization environments, such as synchronization environments 211 and 212. FIG. 2 illustrates only two synchronization environments 211 and 212 for the sake of simplicity; however, any number of multiple synchronization environments 211 and 212 are applicable to the embodiments described herein. The synchronization environments 211 and 212 are self-contained environments and are capable of receiving a search query, retrieving search query results, and saving the search query results. In addition, search query results are broadcast to all other synchronization environments 211 and 212 within the synchronization system 200. The multiple synchronization environments 211 and 212 can be in the same physical location, or they can be located in different geographical locations from each other.

One synchronization environment 211 includes a frontend infrastructure 221. The frontend infrastructure 221 is operable to receive a search query input from a user. A computer can be used to send the search query to the frontend infrastructure 221. A local cache manager 231 is included in the synchronization environment 211 to store search query results. When the frontend infrastructure 221 receives a search query, it checks the local cache manager 231 to see if results for that search query already exist. This function avoids unnecessary duplication of searching. When existing results are not found in the local cache manager 231, then one or more backend search engines 241 are used to retrieve search results in response to the search query obtained from the frontend infrastructure 221. In some synchronization environments 211, thousands of backend search engines 241 are used for searching millions of documents, in order to obtain search query results for the search query input.

When new results for a search query are obtained from the backend search engines 241, the results are stored in the local cache manager 231. In addition, a cache sync notification is created, which provides certain identifier and location information of the search results. The cache sync notification provides a link or pointer to where the actual search results are located. The cache sync notification is sent to a cache synchronization service 251 within the synchronization environment 211.

This newly created cache sync notification is broadcast to all other synchronization environments that are included in the synchronization system 200, such as synchronization environment 212. The broadcast cache sync notification is received by the frontend infrastructure 222 of synchronization environment 212. The frontend infrastructure 222 saves the cache sync notification into the local cache manager 232 of synchronization environment 212. Synchronization environment 212 includes its own backend search engines 242 and a cache synchronization service 252, similar to synchronization environment 211.

FIG. 2A illustrates a computer-implemented synchronization system 200 when a search query originates in the frontend infrastructure 222 of synchronization environment 212. The frontend infrastructure 222 checks for any existing results of the search query in its local cache manager 232. If the results are not found, then the backend search engines 242 conduct a search of the search query and return the search results to the frontend infrastructure 222. The frontend infrastructure 222 saves the search results into a memory of the local cache manager 232. A cache sync notification for this particular search is created to identify the contents and location of the saved results. The cache sync notification is sent to the cache synchronization service 252. The cache sync notification is broadcast to the frontend infrastructure 221 in synchronization environment 211, as well as to the frontend infrastructures of any other synchronization environments within the synchronization system 200.

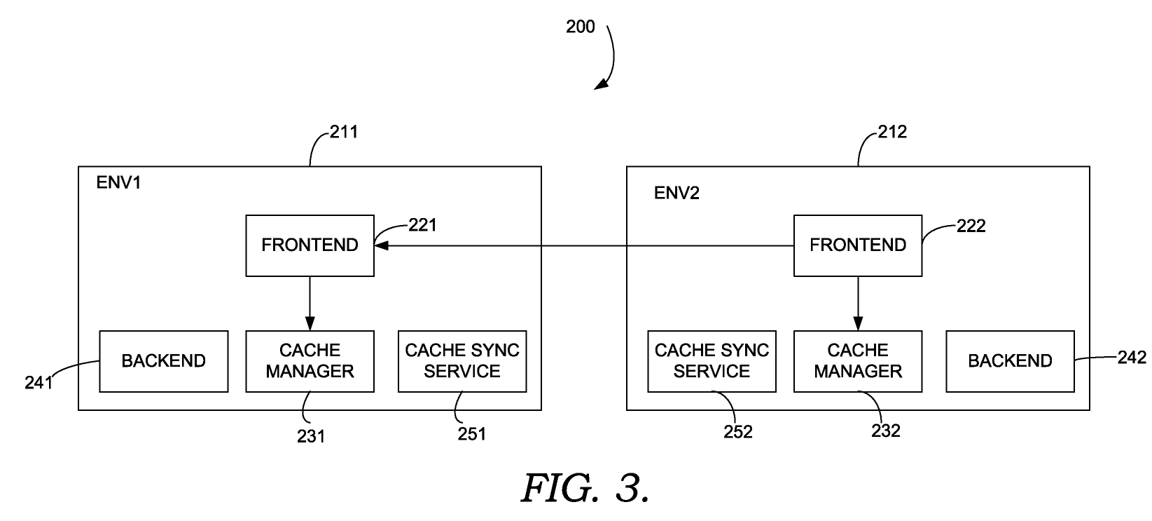

FIG. 3 illustrates a computer-implemented synchronization system 200 as it relates to a retrieval of cached results. The frontend infrastructure 222 of synchronization environment 212 checks its local cache manager 232 for existing results of a received search query. The cache manager 232 may contain a saved cache sync notification for the received search query results, indicating that the actual saved results are located in synchronization environment 211. Therefore, frontend infrastructure 222 requests the search results from frontend infrastructure 221. Frontend infrastructure 221 retrieves the search results from its local cache manager 231, and sends the search results to frontend infrastructure 222. Frontend infrastructure 222 replaces the saved cache sync notification with the actual saved results into its local cache manager 232.

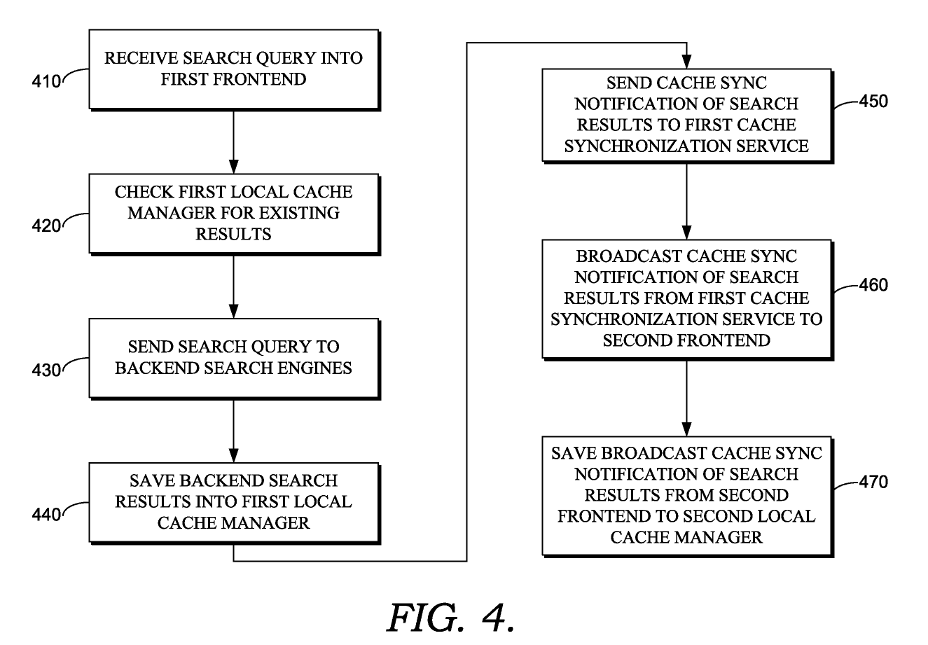

FIG. 4 illustrates a flow diagram for a computer-implemented method of synchronizing available information across multiple synchronization environments. The multiple synchronization environments could be located within the same vicinity or located in different geographical areas. A synchronization environment is a self-contained environment which receives and searches a search query, and saves the search query results.

A search query is received into a first frontend infrastructure of a first synchronization environment in step 410. A first local cache manager for the first synchronization environment is checked to see if results already exist for that particular search query in step 420. If existing results for that search query are not found in the first local cache manager, then the search query is sent to one or more backend search engines of the first synchronization environment in step 430. The search results from the backend search engines are returned to the first frontend infrastructure. The search results are then saved into a memory of the first local cache manager by the first frontend infrastructure in step 440. A cache sync notification is created, which identifies the contents and location of the actual results of the search query. The cache sync notification of search results is sent from the first frontend infrastructure to a first cache synchronization service of the first synchronization environment in step 450. The cache sync notification of search results is then broadcast from the first cache synchronization service to a second frontend infrastructure of a second synchronization environment in step 460. If there are more than two synchronization environments within the synchronization system, then the cache sync notification of search results is broadcast to each frontend infrastructure of each synchronization environment. The cache sync notification that was broadcast to each frontend infrastructure of each synchronization environment is saved to a memory of the respective local cache manager in step 470.

An alternative embodiment provides for broadcasting multiple search results simultaneously. Search results are stored in the cache synchronization service, then multiple results are broadcast simultaneously. The results could be stored for a certain period of time, as an example one to two seconds, then be broadcast at the end of the holding period.

The flow diagram of the computer-implemented method illustrated in FIG. 4 pertains to the condition whereby there are no existing results found in the local cache manager. However, there may be instances in which more than one result is found. An embodiment of the invention provides for time stamping all results that are saved into a local cache manager. This allows the frontend infrastructure to select the most recent result. In addition, the embodiment further provides for disposing of earlier time stamped results. Another embodiment provides for retrieving existing results, then updating the search results with additional new search information.

The above description of the computer-implemented method of FIG. 4 is also applicable to one or more computer-readable storage media containing computer readable instructions embodied thereon that, when executed by a computing device, perform a method of synchronizing available information.

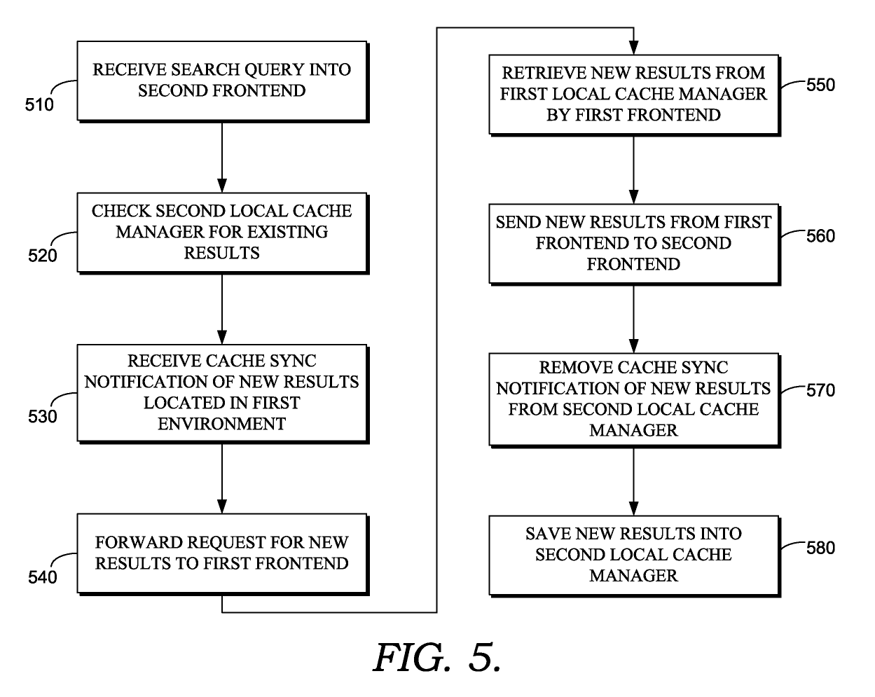

FIG. 5 illustrates a flow diagram for a computer-implemented method of retrieving results from a first local cache manager by a second synchronization environment. A search query is received into a second frontend infrastructure of a second synchronization environment in step 510. The second frontend infrastructure checks a second local cache manager to see if the results for that particular search query already exist in step 520. Upon checking the second local cache manager, a cache sync notification of the desired search results may be found, indicating that the actual results are located in a first synchronization environment in step 530. The second frontend infrastructure forwards a request to the first frontend infrastructure for the desired search results in step 540. The first frontend infrastructure retrieves the desired results of the search query from the first local cache manager in step 550. The retrieved search results are then sent from the first frontend infrastructure to the second frontend infrastructure in step 560. The cache sync notification is then removed from the second local cache manager in step 570, and replaced with the actual results by saving the results to the second local cache manager in step 580.

The above described system, method, and storage media embodiments greatly reduce the amount of backend searching across multiple synchronization environments. This is accomplished by broadcasting search query results to all of the other synchronization environments by means of a cache synchronization service. A cache hit ratio is defined as the number of search query results obtained from cache per number of total search requests. Embodiments of the invention provide a cache hit ratio of greater than 60%, which means that less than half of all search query requests had to be searched by backend search engines. In addition to improving efficiency and reducing costs, the embodiments of the invention also provide consistent results across multiple synchronization environments.

The above described system, method, and storage media embodiments can be implemented for purposes of synchronizing search information via an interconnected computing network. The interconnected computing network could be the Internet, a local area network (LAN), or a wide area network (WAN), for example.

The above described system, method, and storage media embodiments can also be implemented for purposes of synchronizing peer to peer files across multiple environments. As an additional embodiment, frequently accessed files could be stored in the local cache manager of each respective synchronization environment.

Many different arrangements of the various components depicted, as well as embodiments not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the embodiments of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A computer-implemented method of synchronizing available information, the method comprising:
receiving a search query into a first frontend infrastructure of a first synchronization environment;
checking a first local cache manager of the first synchronization environment by the first frontend infrastructure for existing results of the search query;
sending the search query to one or more backend search engines of the first synchronization environment;
saving new results of the search query from the one or more backend search engines into a memory of the first local cache manager;
sending a cache sync notification of the new results from the first frontend infrastructure to a first cache synchronization service of the first synchronization environment; and
broadcasting the cache sync notification of the new results from the first cache synchronization service to a second frontend infrastructure of a second synchronization environment.

2. The computer-implemented method of claim 1, further comprising:
saving the broadcast cache sync notification of the new results received in the second frontend infrastructure to a memory of a second local cache manager of the second synchronization environment.

3. The computer-implemented method of claim 2, further comprising: retrieving results from the first local cache manager by the second synchronization environment.

4. The computer-implemented method of claim 3, wherein said retrieving comprises:
receiving the search query into the second frontend infrastructure;
checking the second local cache manager for existing results of the search query;
receiving the cache sync notification of the new results of the search query from the second local cache manager, wherein the new results are located in the first synchronization environment;
forwarding a request for the new results of the search query to the first frontend infrastructure;
retrieving the new results of the search query from the first local cache manager by the first frontend infrastructure;
sending the new results of the search query from the first frontend infrastructure to the second frontend infrastructure;
removing the cache sync notification of the new results located in the second local cache manager; and
saving the new results into the second local cache manager.

5. The computer-implemented method of claim 1, wherein said broadcasting comprises: broadcasting to one or more additional frontend infrastructures of one or more respective additional synchronization environments.

6. The computer-implemented method of claim 5, wherein the first synchronization environment, the second synchronization environment, and the one or more respective additional synchronization environments each comprise a different geographical location.

7. The computer-implemented method of claim 1, wherein said checking a first local cache manager further comprises: finding multiple existing results for the search query, and selecting a most recent existing result.

8. The computer-implemented method of claim 7, wherein each of the multiple existing results are time stamped.

9. The computer-implemented method of claim 8, further comprising: disposing of earlier time stamped multiple existing results and returning the most recent existing result of the search query to the first frontend infrastructure.

10. The computer-implemented method of claim 1, wherein the broadcasting comprises: broadcasting multiple new results simultaneously.

11. The computer-implemented method of claim 10, wherein the broadcasting multiple new results simultaneously further comprises: storing the multiple new results in the first cache synchronization service until the broadcasting occurs.

12. The computer-implemented method of claim 1, wherein the saving new results comprises saving an updated version of an existing result.

13. The computer-implemented method of claim 1, wherein the method comprises: a method of synchronizing search information via an interconnected computing network.

14. The computer-implemented method of claim 1, wherein the method comprises: a method of synchronizing peer to peer files across multiple environments.

15. The computer-implemented method of claim 14, wherein frequently accessed files are stored in the local cache manager of each respective synchronization environment.

16. A computer-implemented synchronization system, comprising:
a plurality of cache synchronization environments, wherein each of the plurality of cache synchronization environments comprises:
a frontend infrastructure, operable to receive a search query;
one or more backend search engines, operable to receive and search the search query obtained from the frontend infrastructure;
a local cache manager, operable to store search query results, and operable to store cache sync notifications of search query results stored in a different cache synchronization environment; and
a cache synchronization service, operable to send and receive cache sync notifications of search query results to and from one or more frontend infrastructures located in one or more respective cache synchronization environments.

17. The computer-implemented system of claim 16, wherein the frontend infrastructure of a first cache synchronization environment is operable to retrieve search query results from the frontend infrastructure of a second cache synchronization environment.

18. The computer-implemented system of claim 17, wherein the local cache manager of the first cache synchronization environment comprises a cache sync notification of search query results stored in the second cache synchronization environment, and the local cache manager is operable to replace the cache sync notification with retrieved search query results from the second cache synchronization environment.

19. The computer-implemented system of claim 16, wherein the system comprises: a synchronized searching system across multiple environments via an interconnected computing network.

20. The computer-implemented system of claim 16, wherein the system comprises: a peer to peer file synchronization system across multiple synchronization environments.
